(19) United States
(12) Patent Application Publication
(10) Pub. No.: US 2008/0101789 A1
(43) Pub. Date: May 1, 2008

(54) Method and apparatus for setting camera viewpoint based on alarm event or condition

(75) Inventor: Raman Kumar Sharma, Toronto (CA)

Correspondence Address: Gerald Bluhm;Tyco Fire and Security, 50 Technology Drive, Westminster, MA, 01441, US

(73) Assignee: TYCO SAFETY PRODUCTS CANADA LTD.

(21) Appl. No.: 11/589,654

(22) Filed: Oct. 30, 2006

(51) Int. Cl. G03B 17/00

(52) U.S. Cl. 396/427

(57) ABSTRACT

A security system comprises a first camera and at least one sensor being interconnected with the security system. The first camera acquires video data and is movable to at least first and second viewpoints having first and second field of views (FOVs) that are at least partially different from one another. The at least one sensor detects an alarm event and is associated with the first camera and one of the first and second viewpoints of the first camera. A processor receives an alarm signal from the at least one sensor. The processor identifies a desired viewpoint of the first camera associated with the at least one sensor. The desired viewpoint is one of the at least first and second viewpoints. The processor transmits the desired viewpoint to the first camera and the first camera is positioned based on the desired viewpoint.

### BACKGROUND OF THE INVENTION

This invention relates generally to security systems, and more particularly, to security systems which transmit images to remote viewing devices when an alarm condition is detected.

One or more cameras are often integrated with alarm or security systems. The cameras acquire images or video data which may be transmitted in video frames through a low data rate link and then viewed at a remote viewing device located off-site. The remote viewing device may be any viewing platform, such as a mobile phone, personal digital assistant (PDA), laptop computer, and the like.

When an alarm condition or event occurs, a signal is sent to the remote viewing device and the user views the resultant video frames acquired by one or more cameras. Generally, a large time delay is experienced between the time of the event and the time the user views the video frames associated with the event. Therefore, the viewpoint of the camera may not be suitable for viewing the cause of the alarm event, making it difficult to identify the cause and determine if the event is an actual alarm condition or a false alarm.

While viewing the video frames, the user may control and adjust the viewpoint of the camera with an input on the remote viewing device, such as a joystick, mouse or other pointing device. Another large delay is experienced as the remote viewing device transmits the adjustment signal to the security system, which then moves the camera to the new position. Furthermore, the new position may not be better than the previous position and the cause of the alarm condition, such as an intruder, may have moved out of the field of view of the camera and may be difficult to locate. Therefore, video data captured of the alarm condition, which may also be stored on-site, may not be useful to identify an intruder or other cause of the event.

Therefore, a need exists for capturing video data associated with an alarm condition or event detected by a security system. Certain embodiments of the present invention are intended to meet these needs and other objectives that will become apparent from the description and drawings set forth below.

### BRIEF DESCRIPTION OF THE INVENTION

In one embodiment, a security system comprises a first camera and at least one sensor being interconnected with the security system. The first camera acquires video data and is movable to at least first and second viewpoints having first and second field of views (FOVs) that are at least partially different from one another. The at least one sensor detects an alarm event and is associated with the first camera and one of the first and second viewpoints of the first camera. A processor receives an alarm signal from the at least one sensor. The processor identifies a desired viewpoint of the first camera associated with the at least one sensor. The desired viewpoint is one of the at least first and second viewpoints. The processor transmits the desired viewpoint to the first camera and the first camera is positioned based on the desired viewpoint.

In another embodiment, a method for acquiring video data of an event detected within a security system comprises detecting a first event with a first sensor. A first camera is positioned at a first viewpoint which has a first FOV based on the first sensor. Video data is acquired within the first FOV with the first camera.

In another embodiment, a security system comprises at least one camera and at least first and second sensors interconnected with the security system. The at least one camera acquires video data and is movable to change a FOV of the at least one camera. The at least first and second sensors detect alarm events. Means are provided for setting the at least one camera to a first viewpoint to acquire video data. The first viewpoint is associated with at least one of the at least first and second sensors.

### BRIEF DESCRIPTION OF THE DRAWINGS

FIG. 1 illustrates a security system which has a system control panel for monitoring and/or controlling devices installed on a network in accordance with an embodiment of the present invention.

FIG. 2 illustrates exemplary viewpoints of the first and second cameras associated with one or more alarm sensors in accordance with an embodiment of the present invention.

FIG. 3 illustrates a method for setting camera viewpoints to capture video data associated with detected alarm events and conditions in accordance with an embodiment of the present invention.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

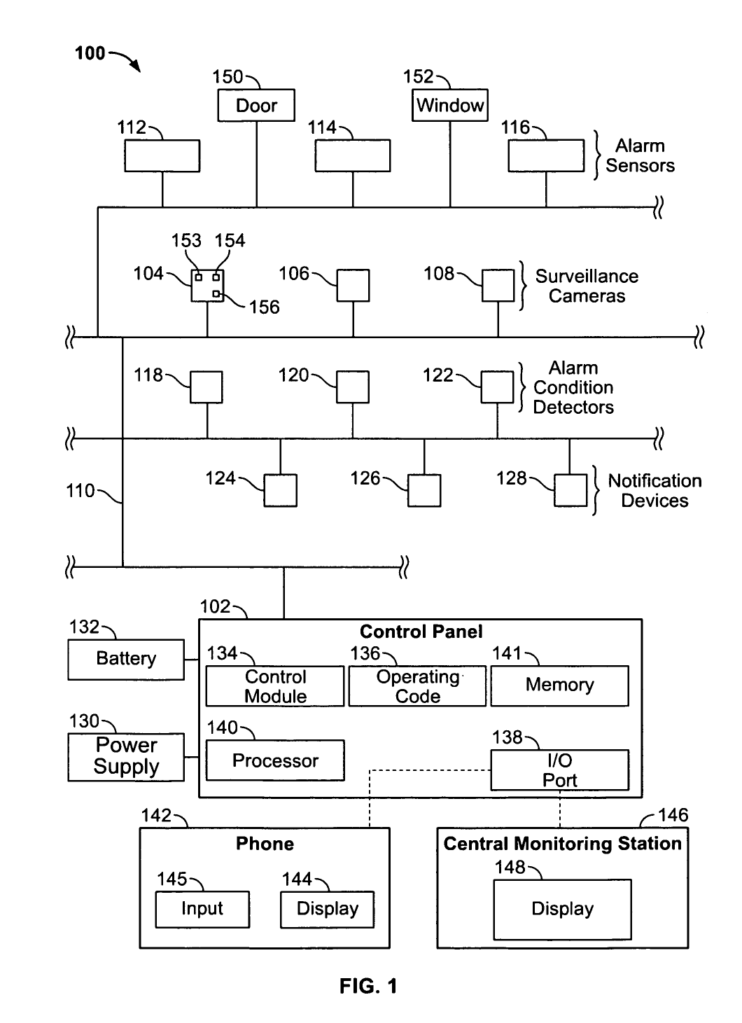

FIG. 1 illustrates a security system 100 which has a system control panel 102 for monitoring and/or controlling devices installed on a network 110. The devices may detect and/or monitor locations and movement of people, animals and machines, detect and/or control door openings and closings, detect alarm conditions such as smoke and fire, notify people within an area about alarm conditions, or accomplish other security functions which may be desired. For example, the system 100 may be used within a light industrial building or a residence.

The system 100 has one or more surveillance camera, such as first camera 104, second camera 106 through N camera 108. Each of the first through N cameras 104-108 may have components such as a processor 153 and memory 154 to enable communication with the system control panel 102 over the network 110, as well as a motor 156 and/or other movement apparatus to enable movement, such as pan and tilt, of the first through N cameras 104-108. Therefore, image data may be detected within a field of view (FOV) which is larger than the actual FOV of the respective camera. The FOV of each camera may be different from any other camera, or a camera may have a FOV which at least partially overlaps with the FOV of at least one other camera. Each of the first through N cameras 104-108 may have predetermined positions, herein referred to as viewpoints, which are stored in the memory 154. Each viewpoint has an FOV and may be defined by parameters such as position, coordinates, zoom factor, and the like. Each viewpoint may be set to view an area associated with one or more alarm events and/or conditions to better capture video data of the cause of the alarm.

First, second through N alarm sensors 112, 114 and 116 are also installed on the network 110. The first through N alarm sensors 112-116 may detect motion, broken glass, door openings and closings, or other alarm events or conditions, each of which may be a triggering event which triggers at least one of the first through N cameras 104-108 to be set to a particular associated viewpoint. For example, the first alarm sensor 112 may be installed proximate to a door 150. If the door 150 is opened when the system 100 is armed, the first alarm sensor 112 may send an alarm signal to the control panel 102 over the network 110. The second alarm sensor 114 may be installed proximate to a window 152. If the window 152 is opened or glass within the window 152 is broken when the system 100 is armed, the second alarm sensor 114 may send an alarm signal to the control panel 102 over the network 110.

The first camera 104 may have a first viewpoint associated with the first alarm sensor 112 and a second viewpoint associated with the second alarm sensor 114. The viewpoints associated with the cameras and sensors may be stored in a memory 141 of the control panel 102. Also, positioning information and/or other parameters may be stored in the memory 154 of each of the cameras 104-108 pertaining to each camera's viewpoint(s). If an alarm condition is detected by the first alarm sensor 112, the control panel 102 may transmit a move signal to command the first camera 104 to move to the first viewpoint. The first camera 104 is thus positioned to capture video images of the event generating the alarm condition, which are then transmitted over the network 110 to the control panel 102. If a subsequent alarm condition is detected by the second alarm sensor 114, for example, the control panel 102 may direct the first camera 104 to move to the second viewpoint.

Alarm condition detectors 118, 120 and 122 may be connected on the network 110 and are monitored by the system control panel 102. The detectors 118-122 may detect fire, smoke, temperature, chemical compositions, or other hazardous conditions which may also be considered to be triggering events. When an alarm condition is sensed, the system control panel 102 may also transmit an alarm signal to one or more notification device 124, 126 and/or 128 through the network 110. The notification devices 124, 126 and 128 may be horns and/or strobes, for example.

As each security system 100 may be configured differently, it should be understood that each security camera 104-108 may be positioned to image an area or region of interest associated with one or more sensors and/or detectors. If the alarm condition is generated by a person entering through the door 150, additional motion sensors may detect the motion of the person as they move about the monitored area. The control panel 102 thus transmits move signals to one or more of the security cameras 104-108 to command the cameras 104-108 to move to different viewpoints based on triggering events detected by the sensors and detectors installed on the system 100.

The system control panel 102 is connected to a power supply 130 which provides one or more levels of power to the system 100. One or more batteries 132 may provide a back-up power source for a predetermined period of time in the event of a failure of the power supply 130 or other incoming power. Other functions of the system control panel 102 include showing the status of the system 100, resetting a part or all of the system 100, silencing signals, turning off strobe lights, and the like.

The network 110 is configured to carry power and communications to the addressable notification devices from the system control panel 102. If addressable, the notification devices 124-128 have a unique address and both send and receive communications to and from the system control panel 102. The first through N cameras 104-108 are addressable and thus each has a unique address on the network 110.

The system control panel 102 has a control module 134 which provides control software and hardware to operate the system 100. Operating code 136 may be provided on a hard disk, ROM, flash memory, stored and run on a CPU card, or other memory. A communication port, such as input/output (I/O) port 138, provides a communications interface at the system control panel 102 with at least one of a central monitoring station 146 and a remote viewing device, such as a mobile phone 142, personal digital assistant (PDA), or laptop computer. The mobile phone 142 may be connected wirelessly, while the central monitoring station 146 may be connected wirelessly, by telephone link, LAN, WAN, internet, and the like.

The central monitoring station 146 is typically located remote from the system 100 and may monitor multiple alarm systems. The central monitoring station 146 may receive communications from the system control panel 102 regarding security problems and alarm conditions as well as real-time video data acquired by the first through N cameras 104-108. The phone 142 may have a display 144 for displaying video data transmitted by the control panel 102 as well as an input 145 for changing the viewpoint and/or position of a camera 104-106 and selecting a desired camera output. The central monitoring station 146 may have one or more displays 148 for displaying video data received from one or more systems 100.

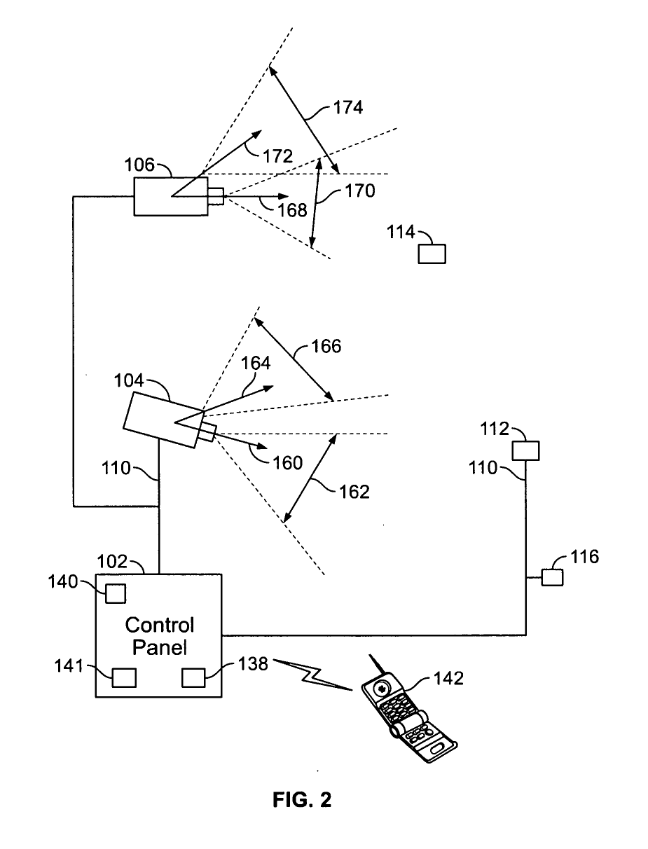

FIG. 2 illustrates exemplary viewpoints of the first and second cameras 104 and 106 associated with one or more alarm sensors. The first camera 104 has first and second viewpoints 160 and 164 having first and second FOVs 162 and 166, respectively. The first viewpoint 160 is associated with both the first and third alarm sensors 112 and 116, while the second viewpoint 164 is associated with the second alarm sensor 114. The second camera 106 has first and second viewpoints 168 and 172 having first and second FOVs 170 and 174, respectively. The first viewpoint 168 is associated with the second alarm sensor 114 while the second viewpoint 172 is associated with a different alarm sensor (not shown).

The viewpoints of the cameras are set such that video data acquired within the FOV is representative of the triggering event. Viewpoints of a camera associated with different sensors may be the same or different, and thus have FOVs which may be different from one another, overlapping, or partially overlapping. For example, a triggering event detected by either the first or third alarm sensor 112 or 116 will result in the first camera 104 moving to the first viewpoint 160. The first and second cameras 104 and 106 both image area associated with the second alarm sensor 114, acquiring video data from different angles and having overlapping FOVs.

When a triggering event is detected by the first alarm sensor 112, the control panel 102 transmits a request to the first camera 104 to move to the first viewpoint 160 which is associated with the first alarm sensor 112. Thus, the first camera 104 acquires image data associated with the first alarm sensor 112, such as area proximate to the door 150 (FIG. 1). For example, the first camera 104 may pan or tilt as necessary as well as adjust a zoom setting to move to the desired viewpoint. The first camera 104 transmits the video data to the control panel 102, which may then transmit at least a portion of the video data to the phone 142 or other portable device via the I/O port 138. The second camera 106 may be simultaneously acquiring video data which is transmitted to the control panel 102, but which may not be transmitted to the phone 142.

If a subsequent triggering event is detected by the second alarm sensor 114, the control panel 102 sends a first request to the first camera 104 to move to the second viewpoint 164 and a second request to the second camera 106 to move to the first viewpoint 168, both of which are associated with the second alarm sensor 114. By automatically moving the applicable cameras based on detected events and/or conditions, the video data captures images causing the triggering event without user input and without the time lag experienced when the user changes the viewpoint remotely.

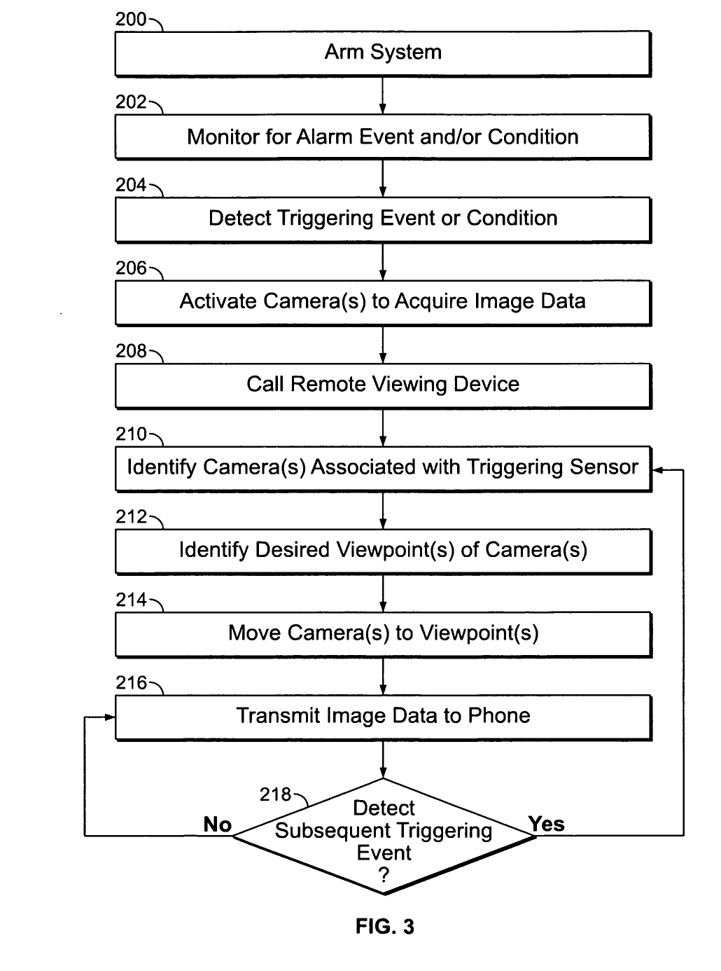

FIG. 3 illustrates a method for setting camera viewpoints to capture video data associated with detected alarm events and conditions. At 200, the system 100 (FIG. 1) is armed. At 202, the control panel 102 monitors for alarm conditions, triggering events, and/or other alarm conditions. Optionally, the first through N cameras 104-108 may not be activated and thus may not be acquiring video data.

At 204, an alarm sensor 112-116 (or other alarm condition detector 118-122) detects an event and transmits an event detection signal over the network 110 to the processor 140 within the control panel 102. At 206, the processor 140 activates one or more of the cameras 104-108. For example, the processor 140 may activate all of the cameras 104-108 installed on the network 110. Optionally, a subset of the cameras or a single camera may be activated based on parameters such as location the sensor detecting the event, location of the camera with respect to the sensor, and the like. The activated cameras 104-108 begin to acquire video data, which is transferred over the network 110 and may be stored in the memory 141. All or a portion of the acquired video may also be stored in the memory 154 at each of the cameras 104-108. The video may be acquired in snapshots, streaming video, at levels of quality depending on the triggering sensor, and the like.

At 208, the processor 140 may initiate a call to the phone 142 (or other remote viewing terminal) using the I/O port 138. The processor 140 may monitor for a signal returned from the phone 142 indicating that the call is established.

At 210, the processor 140 identifies one or more cameras 104-108 that are associated with the triggering sensor, and at 212, the processor 140 identifies a desired viewpoint of the one or more identified cameras 104-108 associated with the triggering sensor. The processor 140 may refer to data stored in the memory 141. Referring to FIG. 2, if the triggering sensor is the first alarm sensor 112, the first camera 104 is identified and the first viewpoint 160 is the desired viewpoint or position.

At 214, the processor 140 sends a move signal over the network 110 to the first camera 104, requesting the first camera 104 to move to the first viewpoint 160. The first camera 104 then moves to the first viewpoint 160, and may access positional information from the memory 154. The first camera 104 (as well as any other cameras activated at 206) continues to acquire image data and transmit image data to the control panel 102. At 216, the processor 140 transmits video data to the phone 142, such as by using I/O port 138. The processor 140 may access the video data stored in the memory 141 and transmit snapshots to the phone 142, or may stream video depending upon the transmission capability and bandwidth. The processor 140 may also compress and/or reduce the video data in order to send more data to the phone 142 or to accomplish faster transmission. Optionally, the transmission protocol may be based on the receiving capability of the phone 142 or other remote viewing device.

The processor 140 continues to monitor for events. If no subsequent event is detected at 218, the method returns to 216 and the processor 140 continues to transmit image data to the phone 142. If a subsequent event is detected at 218, the method returns to 210, where the processor 140 identifies the camera(s) 104-108 associated with the triggering sensor that detected the subsequent event, identifies the viewpoint(s) of the camera(s) 104-108 (212), and transmits a request to move the camera(s) 104-108 to the identified viewpoint(s) (214). It is possible that a subsequent triggering event may be caused by the same sensor, such as a motion sensor detecting a person moving through its detection range, and that the camera(s) 104-108 will not be moved to a different viewpoint.

If the processor 140 transmits video data acquired by the first camera 104 to the phone 142, and then detects a subsequent triggering event which is within the FOV of the second camera 106, the processor 140 may optionally switch the video data being transmitted to the phone 142 from the first camera 104 to the second camera 106. Alternatively, the processor 140 may generate an inquiry or request confirmation from the user of the phone 142 before switching the video data to a different camera output. Optionally, if multiple triggering events are detected associated with multiple cameras 104-108, the processor 140 may choose a default camera 104-108 from which to transmit video while informing the user of the multiple triggering events. The user of the phone 142 may also transmit a message to the processor 140 to request video data from a desired camera. Optionally, if the remote viewing device is a computer or has the capability to display video data acquired by more than one camera 104-108, the processor 140 may transmit data from more than one camera to the device. Optionally, the user may choose to move one or more of the cameras 104-108 manually. A move signal may be generated by the input 145, such as by using a joystick or trackball, to move the camera 104-108 in one or more of pan, tilt, zoom, or to another location or video setting.

It should be understood that viewpoints may also be established to detect other conditions, such as to view an area proximate to an alarm condition detector such as a smoke, fire or chemical detector. The user may view the received video data to determine if a false alarm has been generated, or to determine an appropriate response.

While the invention has been described in terms of various specific embodiments, those skilled in the art will recognize that the invention can be practiced with modification within the spirit and scope of the claims.

What is claimed is:

1. A security system, comprising:
a first camera being interconnected with the security system, the first camera acquiring video data and being movable to at least first and second viewpoints having first and second field of views (FOVs) that are at least partially different from one another;
at least one sensor interconnected with the security system, the at least one sensor detecting an alarm event, the at least one sensor being associated with the first camera and one of the first and second viewpoints of the first camera; and
a processor receiving an alarm signal from the at least one sensor, the processor identifying a desired viewpoint of the first camera associated with the at least one sensor, the desired viewpoint being one of the at least first and second viewpoints, the processor transmitting the desired viewpoint to the first camera, the first camera being positioned based on the desired viewpoint.

2. The security system of claim 1, the at least one sensor further comprising first and second sensors, the first and second sensors being associated with the first and second viewpoints, respectively, of the first camera.

3. The security system of claim 1, the at least one sensor further comprising first and second sensors, the first and second sensors being associated with the first and second viewpoints, respectively, of the first camera, the processor receiving a second alarm signal from the second sensor, the processor transmitting the second viewpoint to the first camera, the first camera being positioned based on the second viewpoint.

4. The security system of claim 1, further comprising means for positioning the first camera based on the desired viewpoint.

5. The security system of claim 1, further comprising a communication port for transmitting at least a portion of the video data acquired by the first camera positioned at the desired viewpoint to a remote viewing device.

6. The security system of claim 1, further comprising a second camera being interconnected with the security system, the second camera acquiring video data and being movable to at least third and fourth viewpoints having third and fourth FOVs that are at least partially different from one another, the third and fourth viewpoints being based on the at least one sensor.

7. A method for acquiring video data of an event detected within a security system, comprising:
detecting a first event with a first sensor;
positioning a first camera at a first viewpoint, the first viewpoint having a first field of view (FOV) based on the first sensor; and
acquiring video data within the first FOV with the first camera.

8. The method of claim 7, further comprising transmitting at least a portion of the video data to a remote viewing device.

9. The method of claim 7, further comprising:
detecting a second event with a second sensor; and
positioning the first camera at a second viewpoint, the second viewpoint having a second FOV based on the second sensor that is at least partially different than the first FOV.

10. The method of claim 7, further comprising:
positioning a second camera at a second viewpoint, the second viewpoint having a second FOV based on the first sensor; and
acquiring video data with the second camera.

11. The method of claim 7, further comprising:
positioning a second camera at a second viewpoint, the second viewpoint having a second FOV based on the first sensor;
acquiring video data with the second camera; and
transmitting at least a portion of the video data acquired with the first and second cameras to a remote viewing device.

12. The method of claim 7, further comprising:
transmitting at least a portion of the video data acquired at the first viewpoint to a remote viewing device;
detecting a second event with a second sensor; and
positioning the first camera at a second viewpoint, the second viewpoint having a second FOV based on the second sensor that is different than the first FOV.

13. The method of claim 7, further comprising:
receiving a move signal from a remote viewing device;
positioning the first camera based on the move signal; and
transmitting at least a portion of the video data acquired by the first camera to the remote viewing device.

14. A security system, comprising:
at least one camera interconnected with the security system and acquiring video data, the at least one camera being movable to change a field of view (FOV) of the at least one camera;
at least first and second sensors interconnected with the security system and detecting alarm events; and
means for setting the at least one camera to a first viewpoint to acquire video data, the first viewpoint being associated with at least one of the at least first and second sensors.

15. The security system of claim 14, further comprising means for transmitting at least a portion of the video data to a remote viewing device.

16. The security system of claim 14, further comprising means for setting the at least one camera to a second viewpoint based on a second alarm event detected by one of the at least first and second sensors.

17. The security system of claim 14, wherein the first and second sensors are associated with the first viewpoint and a second viewpoint, respectively, of the at least one camera, the first and second viewpoints being at least partially different with respect to each other.

18. The security system of claim 14, the at least one camera further comprising first and second cameras, the first and second cameras being associated with at least one of the first and second sensors, the first and second cameras being set at viewpoints to acquire video data based on the at least one of the first and second sensors.

19. The security system of claim 14, further comprising:
a second camera interconnected with the security system and acquiring video data, the second camera having a second viewpoint associated with the second sensor; and
means for setting the second camera to the second viewpoint to acquire video data when a second alarm event is detected by the second sensor.

20. The security system of claim 14, further comprising:
a remote display device comprising a display and an input; and
means for transmitting at least a portion of the video data to the remote display device, the remote display device displaying the video data on the display.
